(19) United States
(12) Patent Application Publication
(10) Pub. No.: US 2018/0153140 A1
(43) Pub. Date: Jun. 7, 2018

(54) EGG WASHING APPARATUS

(71) Applicant: Christopher Rivers, North Chittenden, VT (US)

(72) Inventor: Christopher Rivers, North Chittenden, VT (US)

(21) Appl. No.: 15/828,914

(22) Filed: Dec. 1, 2017

Related U.S. Application Data
(60) Provisional application No. 62/429,310, filed on Dec. 2, 2016.

(51) Int. Cl. A01K 43/00; A46B 13/04; A46B 13/00; A46B 9/00; B08B 3/04; B08B 1/00; B08B 1/04

(52) U.S. Cl. CPC A01K 43/005; A46B 13/04; A46B 13/003; A46B 2200/3073; B08B 3/04; B08B 1/002; B08B 1/04; A46B 9/005

(57) ABSTRACT

A cleaning device for eggs and more specifically relates to an egg washing apparatus structured and arranged to be used by small-scale chicken farmers and people who prefer to purchase free range eggs from their local farmer's market or co-op.

### CROSS-REFERENCE TO RELATED APPLICATION

The present application is related to and claims priority from prior provisional application Ser. No. 62/429,310, filed Dec. 2, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of cleaning devices for eggs and more specifically relates to an egg washing apparatus structured and arranged to be used by small-scale chicken farmers and people who prefer to purchase free range eggs from their local farmer's market or co-op.

### 2. DESCRIPTION OF THE RELATED ART

Eggs are laid by female animals of many different species, including birds, reptiles, amphibians, mammals, and fish, and have been eaten by humans for thousands of years. Bird and reptile eggs consist of a protective eggshell, albumen (egg white), and vitellus (egg yolk), contained within various thin membranes. The most commonly consumed eggs are chicken eggs. Other poultry eggs including those of duck and quail are also eaten. Fish eggs are called roe and caviar.

Eggs contain small amounts of almost every vitamin and mineral required by the human body, including calcium, iron, potassium, zinc, manganese, Vitamin E, Folate and many more. A large egg contains 77 calories, with 6 grams of quality protein, 5 grams of fat and trace amounts of carbohydrates. It's very important to realize that almost all the nutrients are contained in the yolk, the white contains only protein.

There's nothing more satisfying than stepping into your yard or farm to collect wholesome eggs from your very own free-range chickens, unfortunately there is just one problem. As the chickens roam free they are also just as liberal with where they lay their eggs, which often results in eggs getting quite dirty. Further, cleaning one egg at the time is time consuming.

Various attempts have been made to solve problems found in egg washing machine device art. Among these are found in: U.S. Pat. No. 2,929,254 to Basil et al; U.S. Pat. No. 2,929,254 to William Booth; U.S. Pat. No. 2,929,254 to Walter Reading. This prior art is representative of egg washing machine devices.

Ideally, an egg washing apparatus should be user-friendly and safe in-use and, yet should operate reliably and be manufactured at a modest expense. Thus, a need exists for an egg washing apparatus structured and arranged to be used by small-scale chicken farmers and people who prefer to purchase free range eggs from their local farmer's market or co-op and to avoid the above-mentioned problems.

### BRIEF SUMMARY OF THE INVENTION

In view of the foregoing disadvantages inherent in the known cleaning devices for eggs art, the present invention provides an Egg Washing Apparatus. The general purpose of the present invention, which will be described subsequently in greater detail is to provide a cleaning device for eggs and more specifically relates to an egg washing apparatus structured and arranged to be used by small-scale chicken farmers and people who prefer to purchase free range eggs from their local farmer's market or co-op.

An egg washing apparatus comprises: a casing member; a first axle member; a second axle member; a first set of brush members; a second set of brush members; a motor member; and a belt member. The casing member includes a first side wall, a second side wall, a bracket member, and at least one support member. The second side wall is spaced from the first side wall. The bracket member extends between and is attached to top portions of the first side wall and the second side wall. The at least one support member extends between and is attached to bottom portions of the first side wall and the second side wall.

The first axle member includes a main axle portion and an end axle portion. The main axle portion is adapted to be placed in between the first side wall and the second side wall. The end axle portion is adapted to pass through and extend outward from the first side wall. The first axle member extends between and is rotatably attached to a center portion of the first side wall and the second side wall.

The second axle member includes a main axle portion and an end axle portion. The main axle portion is adapted to be placed in between the first side wall and the second side wall. The end axle portion is adapted to pass through and extend outward from the first side wall. The second axle member extends between and is rotatably attached to a center portion of the first side wall and the second side wall and is spaced from the first axle member.

The first set of brush members includes a plurality of large brush members and a plurality of small brush members. The plurality of large and small brush members are alternately attached to the main axle portion of the first axle member in a side-by-side fashion.

The second set of brush members includes a plurality of large brush members and a plurality of small brush members. The plurality of large and small brush members are alternately attached to the main axle portion of the second axle member in a side-by-side fashion. The large and small brush members of the first set of brush members and the second set of large and small brush members of the second set of brush members form a plurality of egg-placement sections.

The motor member includes an axle member and a belt member. The axle member is adapted to be controllably rotated. The motor member is attached to the casing member. The belt member is connected between and around the axle member of the motor member, the end axle portion of the first axle member, and the end axle portion of the second axle member, such that the motor member is adapted to rotate the first and second axle members simultaneously. The egg washing apparatus is adapted to have water pass in between the first and second side walls and through the egg washing apparatus, is adapted to receive and retain and egg within each said egg-placement section, and adapted to have said first and second set of brush members rotated by said motor member to thereby clean each said egg within each respective said egg-placement section.

The present invention holds significant improvements and serves as an Egg Washing Apparatus. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Egg Washing Apparatus, constructed and operative according to the teachings of the present invention.

FIG. 1 shows a top view illustrating an egg washing apparatus according to an embodiment of the present invention.

FIG. 2 is a side view illustrating the belt member and gears of the egg washing apparatus according to an embodiment of the present invention.

FIG. 3 is a perspective view illustrating the egg washing apparatus according to an embodiment of the present invention.

FIG. 4 is a front perspective view illustrating the egg washing apparatus according to an alternate embodiment of the present invention.

FIG. 5 is a top perspective view illustrating the egg washing apparatus according to the alternate embodiment of the present invention of FIG. 4.

FIG. 6 is a cross sectional top view illustrating the first and second sets of brush members according to a variation of the alternate embodiment of the present invention of FIG. 4.

The various embodiments of the present invention will hereinafter be described in conjunction with the appended drawings, wherein like designations denote like elements.

### DETAILED DESCRIPTION

As discussed above, embodiments of the present invention relate to a cleaning device for eggs and more specifically relates to an egg washing apparatus structured and arranged to be used by small-scale chicken farmers and people who prefer to purchase free range eggs from their local farmer's market or co-op.

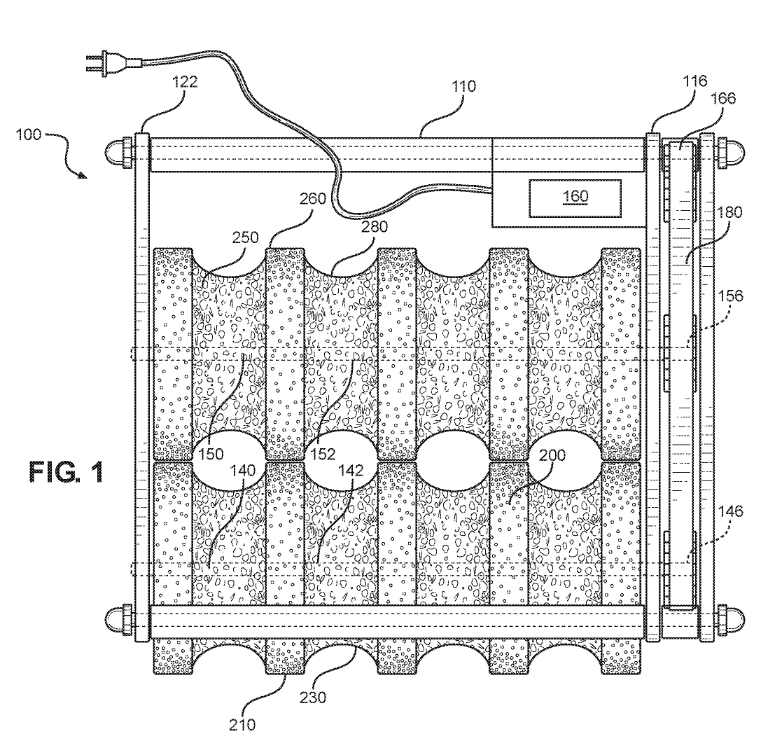

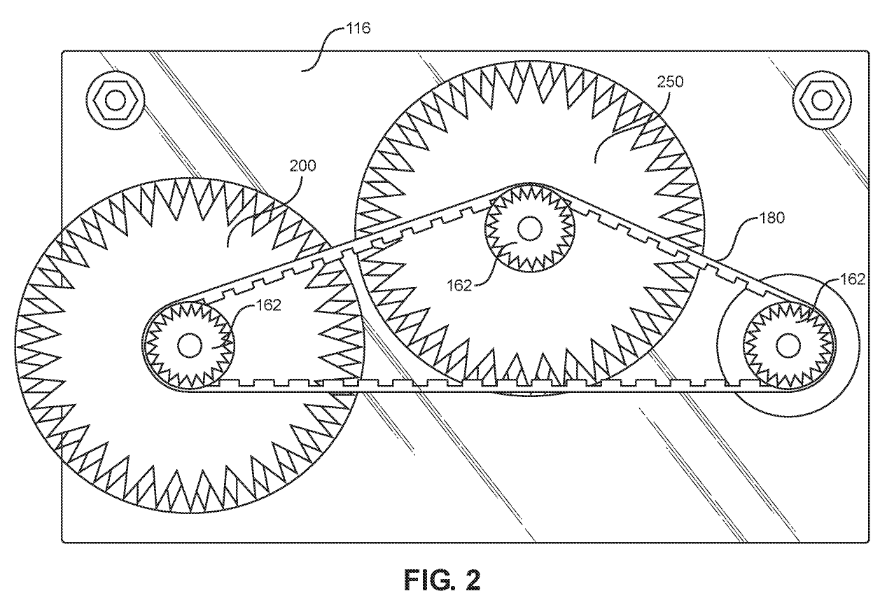

Referring now to FIGS. 1-3, egg washing apparatus 100 comprises a casing member 110; first axle member 140; second axle member 150; first set of brush members 200; second set of brush members 250; motor member 160; and belt member 180. Casing member 110 includes first side wall 116, second side wall 122, bracket member 128, and at least one support member 134. Second side wall 122 is spaced from first side wall 116. Bracket member 128 extends between and is attached to top portions of the first side wall 116 and second side wall 122. At least one support member 134 extends between and is attached to bottom portions of the first side wall 116 and second side wall 122.

Egg washing apparatus 100 may further comprise a third side wall 120 located adjacent and spaced from first side wall 116, on an opposite side of first side wall 116 from second side wall 122, and connected to bracket member 128 and at least one support member 134, such that belt member 180 is located in between first side wall 116 and third side wall 120. Egg washing apparatus 100 further comprising protection panel 118 located in between first side wall 116 and third side wall 120 and connected to top portions of first side wall 116 and third side wall 120, to thereby prevent debris and hands from a user from contacting belt member 180. First side wall 116 and said second side wall 122 are formed from a translucent material. First side wall member 116, second side wall member 122, and third side wall member 120 are formed from a translucent material. The translucent material is chosen from a group of translucent materials consisting of plastic and acrylic.

First axle member 140 includes main axle portion 142 and end axle portion 146. Main axle portion 142 is adapted to be placed in between first side wall 116 and second side wall 122. End axle portion 146 is adapted to pass through and extend outward from first side wall 116. First axle member 140 extends between and is rotatably attached to a center portion of first side wall 116 and second side wall 122. Second axle member 150 includes main axle portion 152 and end axle portion 156. Main axle portion 152 is adapted to be placed in between first side wall 116 and second side wall 122. End axle portion 156 is adapted to pass through and extend outward from first side wall 116. Second axle member 150 extends between and is rotatably attached to a center portion of first side wall 116 and second side wall 122 and is spaced from first axle member 140.

First set of brush members 200 includes plurality of large brush members 210 and plurality of small brush members 230. Plurality of large brush members 210 and small brush members 230 are alternately attached to main axle portion 142 of first axle member 140 in a side-by-side fashion. Second set of brush members 250 includes plurality of large brush members 260 and plurality of small brush members 280. Plurality of large brush members 260 and small brush members 280 are alternately attached to main axle portion 152 of second axle member 150 in a side-by-side fashion. Large brush members 210 and small brush members 230 of first set of brush members 200 and second set of large brush members 260 and small brush members 280 of second set of brush members 250 form a plurality of egg-placement sections 290.

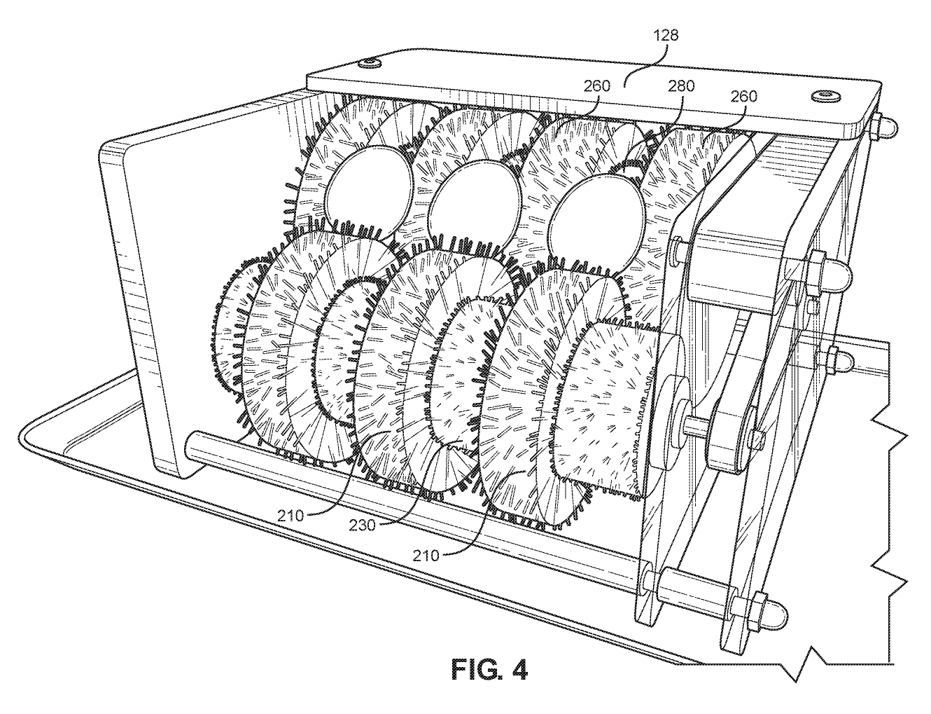

In a preferred embodiment shown in FIGS. 4-6, the large brush members 260 and small brush members 280 of second set of brush members 250 are placed upon main axle portion 152 of second axle member 150 such that they are offset from said first set of brush members 200, such that each respective large brush member 210 of the first set of brush members 200 is in alignment with a small brush member 280 of the second set of brush members 250, and each respective small brush member 230 of the first set of brush members 200 is in alignment with a large brush member 260 of second set of brush members 250, thereby forming alternating offset egg-placement sections 290.

Wherein outer portions of large brush members 210 of first set of brush members 200 are adapted to be located in between outer portions of large brush members 260 of second set of brush members 250; and wherein outer portions of large brush members 260 of second set of brush members 250 are adapted to be located in between outer portions of large brush members 210 of first set of brush members 200.

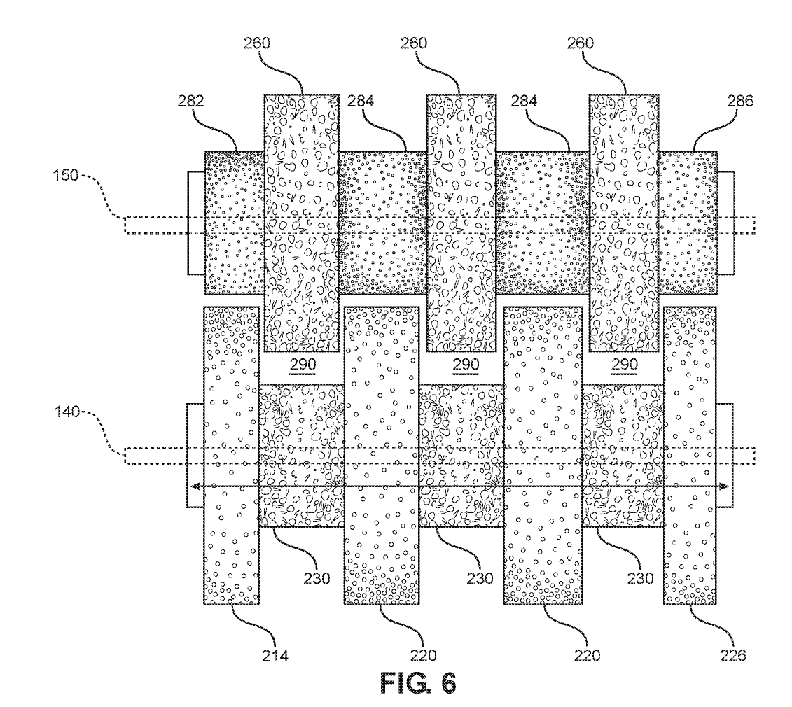

A further modification, shown in FIG. 6, includes wherein large brush members 210 of first set of brush members 200 comprises proximal large brush member 214, at least one center large brush member 220, and distal large brush member 226; and wherein the at least one center large brush member 220 has a width larger than proximal large brush member 214 and distal large brush member 226; and wherein small brush members 280 of second set of brush members 250 comprises proximal small brush member 282, at least one center small brush member 284, and distal small brush member 286; and wherein the at least one center small brush member 284 has a width larger than proximal small brush member 282 and distal small brush member 286, such that the large brush members 214, 220, and 226 of the first set of brush members 200 interdigitate with the large brush members 260 of the second set of brush members 250.

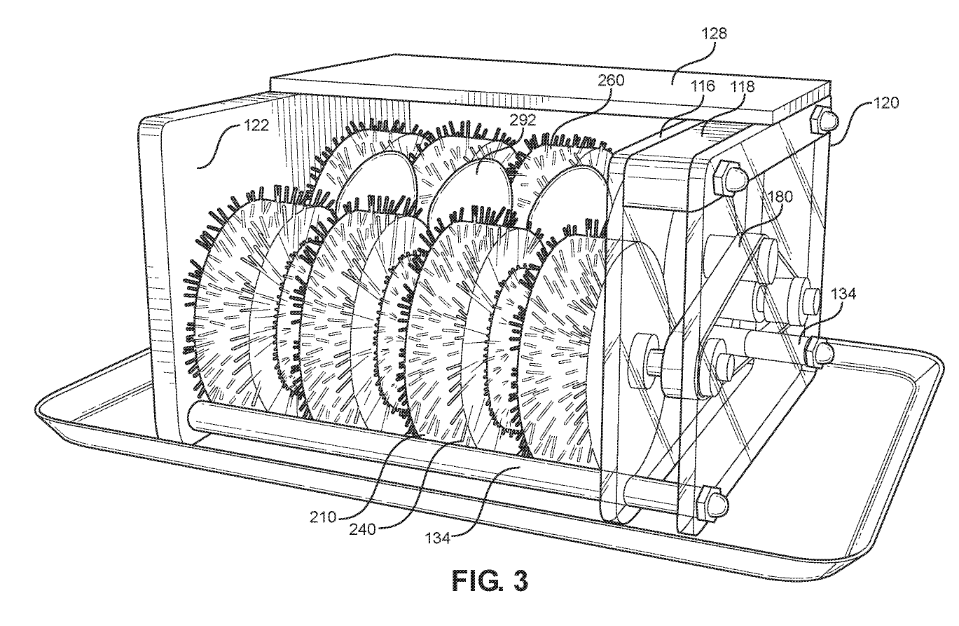

As shown in the embodiment of FIG. 3, the first set of brush members 200 and the second set of brush members 250 each include a plurality of bristle members 240 extending radially outwardly from a center section thereof. The plurality of bristle members 240 may be formed from a plastic material. The plurality of bristle members 240 may also be formed from a cotton material. And finally, the plurality of bristle members 240 may be formed from a nylon material.

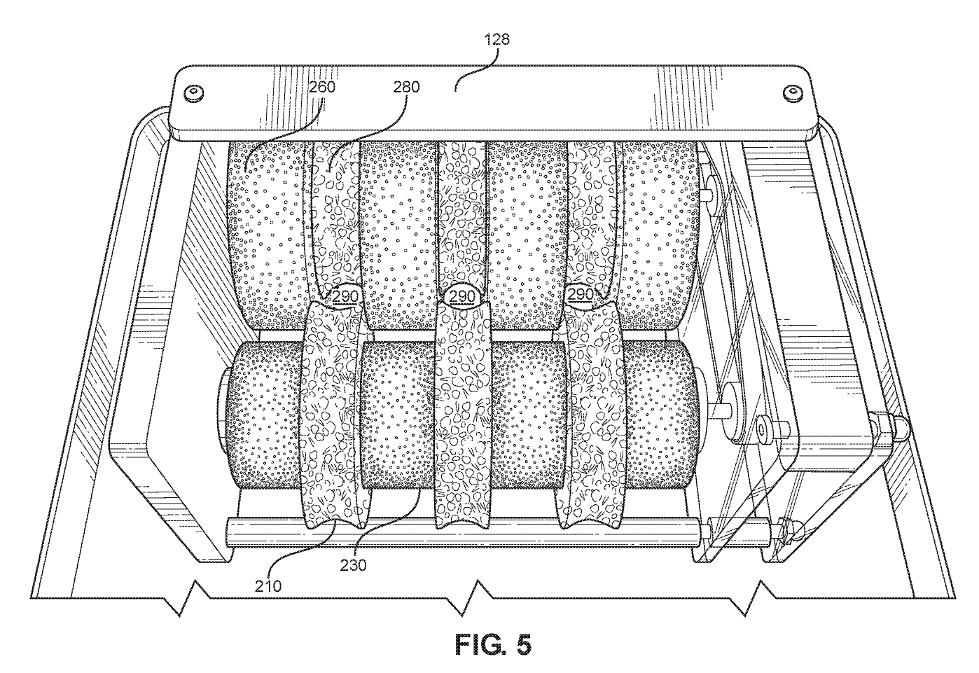

As shown in the embodiment of FIG. 5, the plurality of large brush members 210 of the first set of brush members 200 and the small brush members 280 of the second sets of brush members 250 are formed having a curved egg-contact surface. The first set of brush members 200 and the second sets of brush members 250 are formed from a resilient foam material.

Motor member 160 includes axle member 166 that drives belt member 180. Axle member 166 is adapted to be controllably rotated. Motor member 160 is attached to casing member 110. Belt member 180 is connected between and around axle member 166 of motor member 160, end axle portion 146 of first axle member 140, and end axle portion 156 of second axle member 150, such that motor member 160 is adapted to rotate first axle member 140 and second axle member 150 simultaneously. Motor member 160 is formed as an electric motor. Motor member 160 is located upon the first side wall 116 and in between first axle member 140 and second axle member 150. Motor member 160 can be located upon at least one support member 134; and wherein axle member 166 of motor member 160 is adapted to pass through and extend outward from first side wall 116.

End axle portion 146 of first axle member 140, end axle portion 156 of second axle member 150, and axle member 166 of motor member 160 each includes gear member 162 attached thereto; and wherein belt member 180 is adapted to connect with each gear member 162 to rotate first axle member 140 and second axle member 150. Belt member 180 can be formed as a chain member; and wherein gear members 162 can be formed as sprocket members. Egg washing apparatus 100 is adapted to have water pass in between the first side wall 116 and second side wall 122 and through egg washing apparatus 100, is adapted to receive and retain an egg 292 within each egg-placement section 290, and adapted to have first brush members 200 and second set of brush members 250 rotated by motor member 160 to thereby clean each egg 292 within each respective egg-placement section 290.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An egg washing apparatus comprising:
a casing member including:
a first side wall;
a second side wall;
wherein said second side wall is spaced from said first side wall;
a bracket member;
wherein said bracket member extends between and is attached to top portions of said first side wall and said second side wall; and
at least one support member;
wherein said at least one support member extends between and is attached to bottom portions of said first side wall and said second side wall;
a first axle member including;
a main axle portion;
wherein said main axle portion is adapted to be placed in between said first side wall and said second side wall; and
an end axle portion;
wherein said end axle portion is adapted to pass through and extend outward from said first side wall;
wherein said first axle member extends between and is rotatably attached to a center portion of said first side wall and said second side wall;
a second axle member;
a main axle portion;
wherein said main axle portion is adapted to be placed in between said first side wall and said second side wall; and
an end axle portion;
wherein said end axle portion is adapted to pass through and extend outward from said first side wall;
wherein said second axle member extends between and is rotatably attached to a center portion of said first side wall and said second side wall and is spaced from said first axle member;
a first set of brush members including;
a plurality of large brush members; and
a plurality of small brush members;
wherein said plurality of large and small brush members are alternately attached to said main axle portion of said first axle member in a side-by-side fashion;
a second set of brush members including;
a plurality of large brush members; and
a plurality of small brush members;
wherein said plurality of large and small brush members are alternately attached to said main axle portion of said second axle member in a side-by-side fashion; and
wherein said large and small brush members of said first set of brush members and said second set of large and small brush members of said second set of brush members form a plurality of egg-placement sections; and
a motor member including;
an axle member;
wherein said axle member is adapted to be controllably rotated;
wherein said motor member is attached to said casing member; and
a belt member;
wherein said belt member is connected between and around said axle member of said motor member, said end axle portion of said first axle member, and said end axle portion of said second axle member, such that said motor member is adapted to rotate said first and second axle members simultaneously;
wherein said egg washing apparatus is adapted to have water pass in between said first and second side walls and through said egg washing apparatus, is adapted to receive and retain and egg within each said egg-placement section, and adapted to have said first and second set of brush members rotated by said motor member to thereby clean each said egg within each respective said egg-placement section.

2. The egg washing apparatus of claim 1, wherein said end axle portion of said first axle member, said end axle portion of said second axle member, and said axle member of said motor member each includes a gear member attached thereto; and wherein said belt member is adapted to connect with each said gear member to rotate said first and second axle members.

3. The egg washing apparatus of claim 2, wherein said belt member is formed as a chain member; and wherein said gear members are formed as sprocket members.

4. The egg washing apparatus of claim 1, wherein said large and small brush members of said second set of brush members are placed upon said main axle portion of said second axle member such that they are offset from said first set of brush members, such that each respective large brush member of said first set of brush members is in alignment with a small brush member of said second set of brush members, and each respective small brush member of said first set of brush members is in alignment with a large brush member of said second set of brush members, thereby forming alternating offset egg-placement sections.

5. The egg washing apparatus of claim 1, wherein said plurality of small brush members of said first and second sets of brush members are formed having a curved egg-contact surface.

6. The egg washing apparatus of claim 1, wherein said first and second sets of brush members are formed from a resilient foam material.

7. The egg washing apparatus of claim 1, wherein said first and second sets of brush members each include a plurality of bristle members extending radially outwardly from a center section thereof.

8. The egg washing apparatus of claim 7, wherein said plurality of bristle members are formed from a plastic material.

9. The egg washing apparatus of claim 7, wherein said plurality of bristle members are formed from a cotton material.

10. The egg washing apparatus of claim 7, wherein said plurality of bristle members are formed from a nylon material.

11. The egg washing apparatus of claim 1, wherein said motor member is formed as an electric motor.

12. The egg washing apparatus of claim 1, wherein said motor member is located upon said first side wall and in between said first and second axle members.

13. The egg washing apparatus of claim 1, wherein said motor member is located upon said at least one support member; and wherein said axle member of said motor member is adapted to pass through and extend outward from said first side wall.

14. The egg washing apparatus of claim 4, wherein outer portions of said large brush members of said first set of brush members are adapted to be located in between outer portions of said large brush members of said second set of brush members; and wherein outer portions of said large brush members of said second set of brush members are adapted to be located in between outer portions of said large brush members of said first set of brush members.

15. The egg washing apparatus of claim 4, wherein said large brush members of said first set of brush members comprises a proximal large brush member, at least one center large brush member, and a distal large brush member; and wherein said center large brush member has a width larger than said proximal large brush member and said distal large brush member; and wherein said small brush members of said second set of brush members comprises a proximal small brush member, at least one center small brush member, and a distal small brush member; and wherein said center small brush member has a width larger than said proximal small brush member and said distal small brush member, such that said large brush members of said first set of brush members interdigitate with said large brush members of said second set of brush members.

16. The egg washing apparatus of claim 1, further comprising a third side wall located adjacent and spaced from said first side wall, on an opposite side of said first side wall from said second side wall, and connected to said bracket member and said at least one support member, such that said belt member is located in between said first and third side walls.

17. The egg washing apparatus of claim 16, further comprising a protection panel located in between said first and third side walls and connected to top portions of said first and third side walls, to thereby prevent debris and hands from a user from contacting said belt member.

18. The egg washing apparatus of claim 1, wherein said first and said second side walls are formed from a translucent material.

19. The egg washing apparatus of claim 16, wherein said first, said second, and said third side walls are formed from a translucent material.

20. The egg washing apparatus of claim 19, wherein said translucent material is chosen from a group of translucent materials consisting of plastic and acrylic.
